(19) United States
(12) Patent Application Publication
(10) Pub. No.: US 2025/0380211 A1
(43) Pub. Date: Dec. 11, 2025

(54) METHOD FOR ACCESS NETWORK NODE, METHOD FOR CORE NETWORK NODE, METHOD FOR USER EQUIPMENT, ACCESS NETWORK NODE, CORE NETWORK NODE, AND USER EQUIPMENT

(71) Applicant: NEC Corporation, Minato-ku, Tokyo (JP)

(72) Inventor: Maxime GRAU, Tokyo (JP)

(73) Assignee: NEC Corporation, Minato-ku, Tokyo (JP)

(21) Appl. No.: 18/877,378

(22) PCT Filed: Jun. 23, 2023
(86) PCT No.: PCT/JP2023/023271

§ 371 Date: Dec. 20, 2024

(30) Foreign Application Priority Data
Jul. 1, 2022 (GB) 2209742.2

(51) Int. Cl. H04W 52/02; H04W 28/02; H04W 48/10

(52) U.S. Cl. CPC H04W 52/0206; H04W 28/0221; H04W 48/10; H04W 52/0235

(57) ABSTRACT

A method for an access network node for determining a network energy saving configuration, includes transmitting a broadcast within a cell operated by the access network node to cause User Equipment (UEs), that are camping in the cell in an Idle mode to respond to the access network node; receiving responses from Idle mode UEs that are camped on the cell and determining, using the responses, an estimate of the number of Idle mode UEs that are camped on the cell; and determining the network energy saving configuration for the access network node using the estimated number of Idle mode UEs that are camped on the cell. Beneficially, the method allows for an accurate determination of a load of a cell, which is advantageous in the context of making network energy saving decisions.

### TECHNICAL FIELD

The present disclosure relates to a communication system.

### BACKGROUND ART

The present disclosure relates to a wireless communication system and devices thereof operating according to the 3rd Generation Partnership Project (3GPP) standards or equivalents or derivatives thereof. The disclosure has particular but not exclusive relevance to energy saving techniques in the so-called ‘5G’ or ‘New Radio’ systems (also referred to as ‘Next Generation’ systems) and similar systems.

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication between the UEs and the base station is controlled using the so-called Radio Resource Control (RRC) protocol. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station ('NR-BS') or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and 3GPP TS 37.340 V16.7.0 define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

The term base station or RAN node is used herein to refer to any such node. The energy consumption of base stations and other similar access network nodes represents a major operational expenditure for network operators, in addition to presenting concerns with respect to the environmental impacts of operating telecommunications networks. There are various tools to save energy at the network side. For example, capacity cells (i.e. cells that are deployed for assisting certain areas in peak times) can be switched off and neighbouring cells are aware of whether the capacity cell is available or not. This function allows, for example in a deployment where capacity boosters can be distinguished from cells providing basic coverage, to optimise energy consumption enabling the possibility for an E-UTRA cell or an E-UTRA-New Radio Dual Connectivity (EN-DC) cell providing additional capacity via single or dual connectivity, to be switched off when its capacity is no longer needed and to be re-activated on a need basis. The decision is typically based on cell load information. The switch-off decision may also be taken by an Operations and Maintenance (O&M) node, or another suitable core network node.

### SUMMARY OF INVENTION

### Technical Problem

The base station may initiate handover actions in order to off-load the cell being switched off and may indicate the reason for handover with an appropriate cause value to support the target node in taking subsequent actions, e.g. when selecting the target cell for subsequent handovers.

offloaded to neighbouring cells. However, this may not always be feasible, e.g. for coverage cells if no other cell is available (as the network still has to ensure service to UEs). Moreover, in some cases switching off an entire cell would result in neighbouring cells using more power (to enhance their coverage) than it would save for the cell being switched off. It would also cause some overhead signalling related to handover of UEs to a suitable neighbour cell.

An efficient implementation of network energy saving (NES) by a base station may include the following steps: 1) evaluate the current total load on the cell (optionally taking into account the load in neighbouring cells and in the core network): 2) determining an adequate NES configuration from the available configurations (for example switching off a cell of the base station); and 3) implementing the determined NES configuration. An important aspect of this process, therefore, is to have a good understanding of the load on the cells.

Generally speaking, the network knows the number of UEs in RRC Connected mode (sometimes referred to as NR RRC Connected mode) and/or RRC Inactive mode (sometimes referred to as NR RRC Inactive mode) as well as the number of UEs which are capable of network energy saving for a given serving cell. However, the network is not aware of the number of UEs which are camping on a cell in RRC Idle mode (sometimes referred to NR RRC Idle mode), as these UEs do not have an RRC connection with the serving cell. Consequently, such Idle mode UEs do not signal that they are camping on the serving cell until such time as the UE updates its tracking area as part of a Tracking Area Update (TAU) procedure (which can take place periodically or when a UE moves into the cell of a new Tracking Area (TA) to which the UE is not registered).

There is a desire to make better network energy saving decisions. The base stations can do this if they have more accurate load information of one or more cells they control and/or more accurate load information of neighbouring cells. In particular, if a base station has more accurate load information that includes information on the number of Idle mode UEs camping on a cell and/or camping on neighbouring cells, then the base station can make better decisions about implementing the available network energy saving configurations.

### Solution to Problem

Accordingly, the present disclosure seeks to provide methods and associated apparatus that address or at least alleviate (at least some of) the above-described issues. The present disclosure is set out in the appended independent claims. Optional features are set out in the appended dependent claims.

According to one aspect the present disclosure provides a method for an access network node, the method comprising: transmitting broadcast information within a cell operated by the access network node to cause at least one User Equipment, UE, that is camping in the cell in an Idle mode to transmit a message to the access network node: receiving the message from an Idle mode UE among the at least one UE, in a case where the Idle mode UE starts camping on the cell and/or stops camping on the cell, or the Idle mode UE wakes up from the Idle mode: and determining, using the message, an estimate of the number of the at least one UE.

According to another aspect the present disclosure provides a method for a core network node, the method comprising: maintaining a record of at least one User Equipment, UE, in an Idle mode, including, for each of the at least one UE in the Idle mode, an identifier of a cell on which the each of the at least one UE in the Idle mode is camped: receiving first information from a first access network node indicating that a first UE has started to camp on a cell of the first access network node: and using the first information to update the record for the first UE to reflect the cell on which the first UE has started to camp.

According to another aspect the present disclosure provides a method for a user equipment, UE in an Idle mode, the method comprising: receiving broadcast information within a cell operated by an access network node, transmitting, to the access network node, a message in a case where the UE starts camping on the cell and/or stops camping on the cell, or the UE wakes up from the Idle mode, and wherein the message is used, by the access network node, to determine an estimate of the number of at least one UE that is camping in the cell in the Idle mode.

According to another aspect the present disclosure provides an access network node comprising: means for transmitting broadcast information within a cell operated by the access network node to cause at least one User Equipment, UE, that is camping in the cell in an Idle mode to transmit a message to the access network node; means for receiving the message from an Idle mode UE among the at least one UE, in a case where the Idle mode UE starts camping on the cell and/or stops camping on the cell, or the Idle mode UE wakes up from the Idle mode: and means for determining, using the message, an estimate of the number of the at least one UE.

According to another aspect the present disclosure provides a core network node comprising: means for maintaining a record of at least one User Equipment, UE, in an Idle mode, including, for each of the at least one UE in the Idle mode, an identifier of a cell on which the each of the at least one UE in the Idle mode is camped: means for receiving first information from a first access network node indicating that a first UE has started to camp on a cell of the first access network node: and means for using the first information to update the record for the first UE to reflect the cell on which the first UE has started to camp.

According to another aspect the present disclosure provides a user equipment, UE in an Idle mode, the UE comprising: means for receiving broadcast information within a cell operated by an access network node, means for transmitting, to the access network node, a message in a case where the UE starts camping on the cell and/or stops camping on the cell, or the UE wakes up from the Idle mode, and wherein the message is used, by the access network node, to determine an estimate of the number of at least one UE that is camping in the cell in the Idle mode.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the disclosure will now be described, by way of examples, with reference to the accompanying drawings in which:

FIG. 1 illustrates schematically a mobile (cellular or wireless) telecommunication system to which example embodiments of the disclosure may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1;

FIG. 5 is a schematic signalling (timing) diagram illustrating the interactions in one example between a UE, base stations, and a core network, when the UE joins a cell of the system illustrated FIG. 1;

FIG. 6 is a schematic signalling (timing) diagram illustrating the interactions in another example between a UE and base stations when the UE leaves a cell of the system illustrated in FIG. 1;

FIG. 7 is a schematic signalling (timing) diagram illustrating the interactions in another example between a UE and a base station when the base station signals the UE to use an uplink (UL) resource to indicate its presence;

FIG. 8 is a schematic signalling (timing) diagram illustrating the interactions in another example between a first base station and a second base station when the first base station requests load information from the second base station; and

FIG. 9 is a schematic signalling (timing) diagram illustrating the interactions in another example between a first base station, a core network, and a second base station when the first base station requests load information from the second base station via the core network.

### DESCRIPTION OF EMBODIMENTS

### Overview

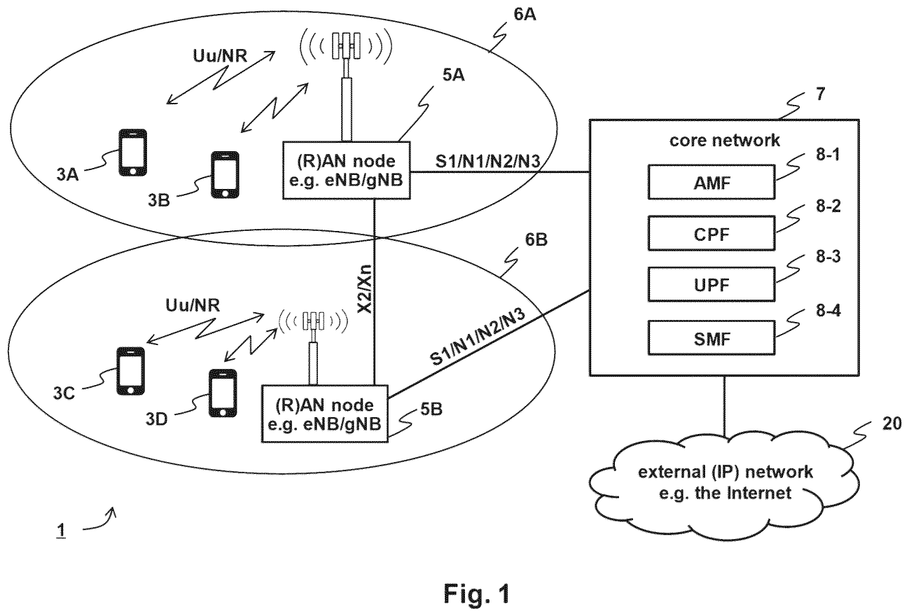

FIG. 1 illustrates schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst four mobile devices 3A, 3B, 3C and 3D and two base stations 5A and 5B are shown in FIG. 1 for illustration purposes, the system, when implemented, will typically include other base stations/(R)AN nodes and mobile devices (UEs).

Each base station 5 controls one or more associated cells 6 (either directly or via other nodes such as home base stations, relays, remote radio heads, distributed units, and/or the like). A base station 5 that supports Next Generation/5G protocols may be referred to as a ‘gNB’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 may be connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 8-2 and one or more user plane functions (UPFs) 8-3. The core network 7 will also include the so-called Access and Mobility Management Function (AMF) 8-1 in 5G, or the Mobility Management Entity (MME) in 4G, that is responsible for handling connection and mobility management tasks for the mobile devices 3, and the Session Management Function (SMF) 8-4 that is responsible for handling communication sessions for the mobile devices 3 such as session establishment, modification and release. The core network 7 is coupled (via the UPF 11) to a data network 20, such as the Internet or a similar Internet Protocol (IP) based network.

In this system 1, network energy savings may generally be realised as follows:
Evaluating the network's current total load—for instance, by calculating the loads in a given cell associated with UEs in Active, Inactive and Idle modes, an accurate estimate of the cell's load at a given point in time can be calculated. Optionally, this evaluation may also consider loads of neighbouring cells, as well as the load on nodes in the core network.
Determining an appropriate network energy saving configuration for the network based on the evaluation.
Implementing the determined configuration.

### User Equipment (UE)

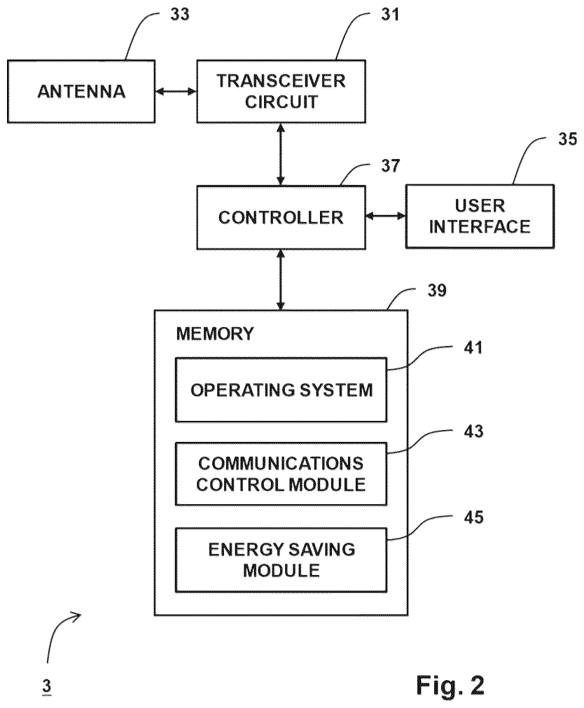

FIG. 2 is a block diagram illustrating the main components of the mobile device (UE) 3 shown in FIG. 1. As shown, the UE 3 includes a transceiver circuit 31 which is operable to transmit signals to and to receive signals from one or more connected nodes via one or more antennas 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and an energy saving module 45.

The communications control module 43 is responsible for handling (generating/sending/receiving) signalling messages and uplink/downlink data packets between the UE 3 and other nodes, including (R)AN nodes 5 and core network nodes. The signalling may comprise control signalling, (e.g. via system information or RRC) related to the energy saving operation. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an SDAP sub-module, an IP sub-module, an RRC sub-module, etc.

The energy saving module 45 is responsible for operations relating to energy saving (by the UE 3 itself and/or by network nodes such as the access network node/base station 5). Energy saving by the UE itself is typically achieved by turning off certain components (e.g. the transceiver circuit 31) for certain periods. As will be explained in more detail below, in the following example embodiments, the UE 3 can assist the network perform energy saving by taking various actions that help the network to obtain a more accurate picture of the actual load currently on the network.

### Access Network Node (Base Station)

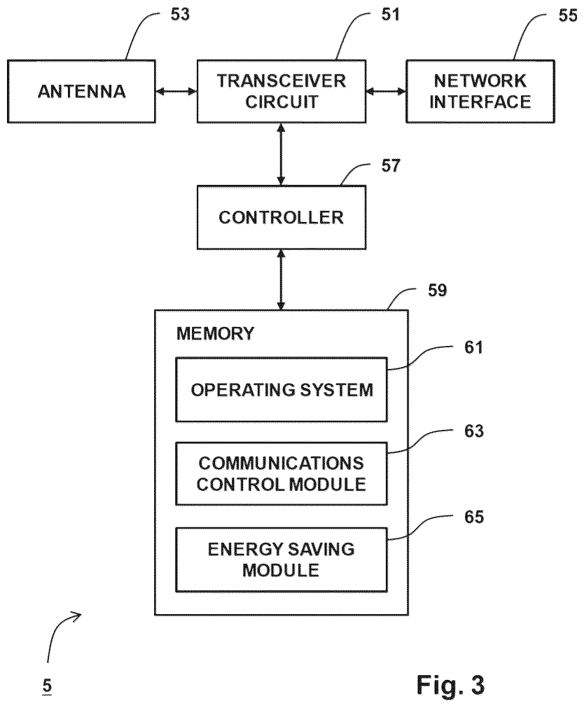

FIG. 3 is a block diagram illustrating the main components of the base station 5 (or a similar access network node) shown in FIG. 1. As shown, the base station 5 includes a transceiver circuit 51 which is operable to transmit signals to and to receive signals from one or more connected UEs 3 via one or more antennas 53 and to transmit signals to and to receive signals from other network nodes (either directly or indirectly) via a network interface 55. The network interface 55 typically includes an appropriate base station to base station interface (such as an X2/Xn interface), and an appropriate base station to core network interface (such as an S1/N1/N2/N3 interface). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and an energy saving module 65.

The communications control module 63 is responsible for handling (generating/sending/receiving) signalling between the base station 5 and other nodes, such as the UE 3 and the core network nodes. The signalling may comprise control signalling (e.g. via system information or RRC) related to the energy saving operation. It will be appreciated that the communications control module 63 may include a number of sub-modules ('layers' or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The energy saving module 65 is responsible for operations relating to energy saving (by the UE 3 and/or by the access network node/base station 5 itself). Energy saving is typically achieved by turning off certain components (e.g. the transceiver circuit 51) for certain periods.

### Core Network Function

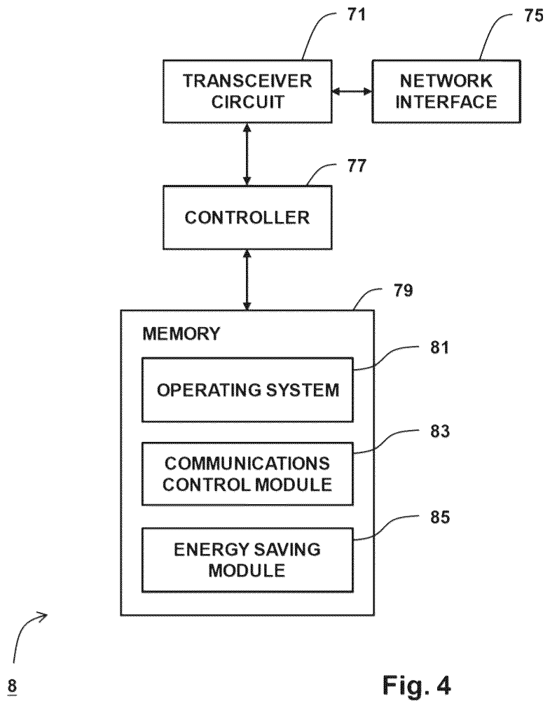

FIG. 4 is a block diagram illustrating the main components of a generic core network node or function 8, such as the AMF 8-1, CPF 8-2, the UPF 8-3 or the SMF 8-4 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an energy saving module 85 (which may be optional).

The communications control module 83 is responsible for handling (generating/sending/receiving) signalling between the core network function and other nodes, such as the UE 3, the base station 5, and other core network nodes. The signalling may include for example a UE context/UE capability indication of a UE 3 related to energy saving.

If present, the energy saving module 85 is responsible for operations relating to energy saving (e.g. by the UE 3 and/or by the access network node/base station 5).

### DETAILED DESCRIPTION

The following is a description of how network loads may be determined which allows the network to make better network energy savings decisions within the system 1 shown in FIG. 1. As will be explained in the examples given below, this is achieved by obtaining load information for the Idle mode UEs in the network and specifically within the cells of the network. Of course, determining load information for the Idle mode UEs must be carried out in an energy efficient manner or the process itself might require more energy than can be saved using the network energy saving measures.

One solution to determine load information for idle mode UEs in the network is to automatically track UEs that are in Idle mode. Specifically, if the UE is configured to perform a Tracking Area Update (TAU) when it joins a new cell, or when it leaves an old cell and joins a new cell, a node 8 in the core network 7 can keep track of the number of Idle mode UEs in the network as a whole and in each cell.

If the UEs are configured to perform a Tracking Area Update (TAU) when they join a new cell and when they leave an old cell, then each base station 5 can track the number of Idle mode UEs in each cell it is controlling without obtaining this information from the core network 7.

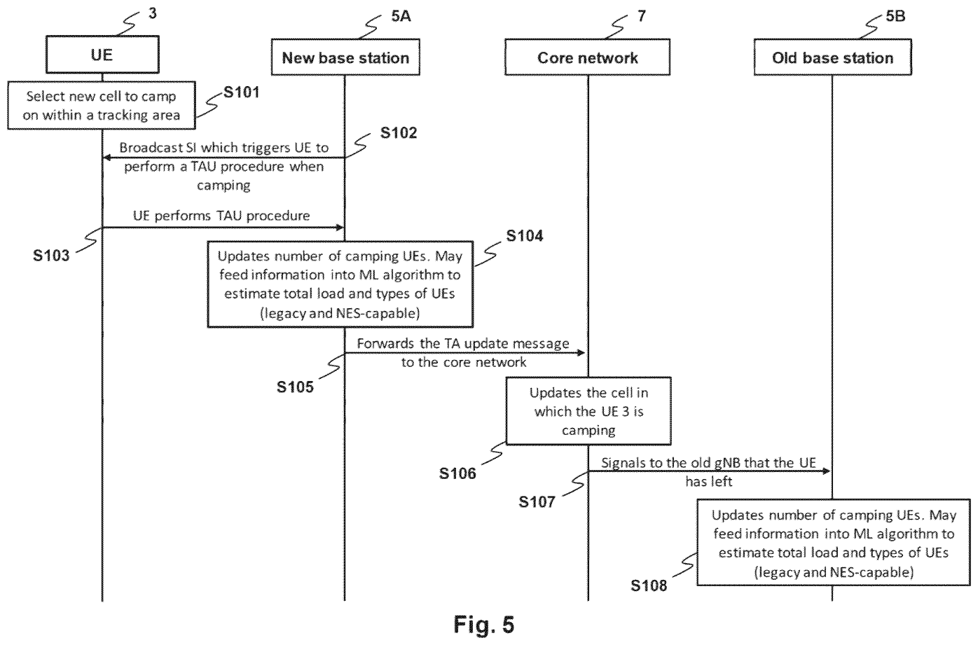

A more detailed description of this solution will now be described with reference to the signalling diagram shown in FIG. 5. As shown in S101, a UE 3 operating in Idle mode selects a new cell on which to camp. In legacy systems, if the selected cell is part of a new Tracking Area (TA), then the UE 3 would perform a Tracking Area Update (TAU) procedure so that the core network 7 knows the new TA in which the UE can be found. However, if the selected cell is part of the same TA that the UE was in when it camped in the previous cell, then in a legacy system, the UE 3 would not perform a TAU procedure.

The new cell which the UE 3 has selected is operated by new base station 5A. This base station broadcasts (as shown in S102), in system information (SI), information which triggers UEs which newly camp on its cell to perform a TA Update procedure regardless of whether or not the Tracking Area has changed. The new base station 5A may broadcast such information in a Master Information Block (MIB), a System Information Block (SIB), or in other system information as appropriate. Accordingly, in S103 the UE 3 contacts the base station 5A to start the normal tracking area update procedure. In response to receiving this TAU update message from the UE 3, the new base station 5A updates the number of UEs camping on its cell to include the UE 3 in S104 and forwards, in S105, the TA update message to the core network 7 (e.g. to the AMF 8-1) in the usual way.

When the core network 7 receives the TA update message, it updates the TA accordingly. In this example embodiment, the core network 7 also maintains a record of the Idle mode UEs and the respective cell in which they are currently camped. Therefore, in response to receiving the TA update message from the new base station 5A, the core network 7 updates, in S106, the cell in which the idle mode UE 3 is camped in its tables and informs, in S107, the old base station 5B that controls the cell in which the UE was previously camped, that the UE has stopped camping in its cell. In S108, the old base station 5B updates the number of Idle mode UEs that are camping on its cell accordingly. Although not shown in FIG. 5, when UEs that are camped on the cell of base station 5A leave and camp on the cell of another base station (e.g. base station 5B), the core network will inform the base station 5A that the UE has changed the cell on which it is camping and so the base station 5A can update the number of cells that are camped on its cell accordingly.

In this way, each base station 5 can accurately keep track of the number of Idle mode UEs that are camped on its cell—which information the base station 5 can use to make better informed decisions about its Network Energy Saving configuration. Instead of incrementing and decrementing the count of UEs in its cell as described above, the base station can instead feed this information about the number of Idle mode UEs that are camped on its cell together with information about RRC connected mode UEs into a Machine Learning (ML) algorithm to estimate the total cell load and the types of UEs (legacy and NES capable) in the cell. Such an ML algorithm can be fed other information as well, such as the traffic patterns over a period of time of the base station 5 concerned as well as the traffic patterns of other neighbouring base stations which will allow the ML algorithm to learn the optimum NES configuration that will maximise energy savings within the network for a given traffic pattern within the base station and its neighbours.

As described above, FIG. 5 illustrates an example embodiment in which the base station 5 triggers a UE 3 to perform a TAU procedure when the UE 3 camps on a new cell, based on information broadcast in its system information.

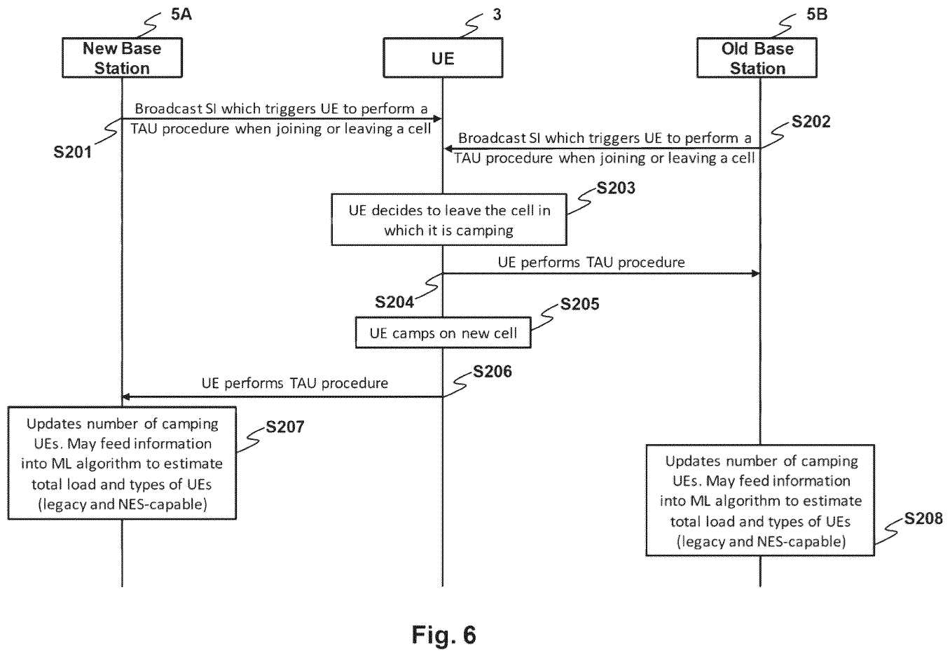

In an alternative example embodiment, both the new base station 5A and the old base station 5B may broadcast information in its system information instructing Idle mode UEs that are intending to camp on its cell in the case of the new base station 5A, and that are already camped on its cell in the case of the old base station 5B, to perform a TA update procedure when they respectively join and leave (stop camping) on the respective cell. Such a procedure is illustrated in FIG. 6.

As shown in FIG. 6, at S201 the new base station is configured to broadcast, in system information (SI), information which indicates to the Idle mode UEs that when they start to camp on the cell of the base station 5A or when they stop camping on the cell of the base station 5A, that they should perform a TA update procedure. In an analogous manner to S201, the old base station 5B also broadcasts, in system information (SI), information which indicates to the Idle mode UEs that when they start or stop camping on the cell of the base station 5B, that they should perform a TA update procedure. Again, the broadcast information may be broadcast in a Master Information Block (MIB), a System Information Block (SIB), or in other system information as appropriate.

Accordingly, and as illustrated in FIG. 6, when the UE 3 decides, in S203, to leave the cell in which it is camping, the UE initiates a TA update procedure in S204 towards the old base station 5B. Then, the UE camps on the new cell (S205) and initiates a TA update procedure in S206 towards the new base station 5A. In response to receiving the respective TAU update message from the UE 3, the base stations 5A and 5B respectively update the number of UEs camping on their cell to include and exclude the UE 3 in S207 and S208.

Beneficially, therefore, according to this example embodiment, each base station 5 can keep track accurately of the number of Idle mode UEs that are camping on its cell without relying on being told by the core network 7 (or another base station) when a UE has stopped camping on its cell. Indeed, such an example embodiment, does not require the core network to be involved. However, in some example embodiments, the base stations will forward the received TAU messages they receive from the UEs to the core network 7 so that the core network 7 can also keep track of all the Idle mode UEs within the different cells of the network.

In the example embodiments described above, the UEs were triggered to perform a TA update when they start camping on a new cell and/or when they stop camping on a cell. The purpose of triggering the TA update procedure is to inform the base station 5 that the Idle mode UE 3 is camping or is about to stop camping in the base station's cell. As those skilled in the art will appreciate it is not essential that the UE performs a TA update. A new dedicated procedure may be established that allows the UE to inform the base station that the Idle mode UE is now camping on the base station's cell and/or to inform the base station that the UE is about to stop camping on its cell. The advantage of relying on the TA update procedure is that it is an existing low energy procedure that is easy to implement. However, a new procedure would allow more information to be communicated by the UE to the base station. For example, a new procedure would allow the UE to identify the previous cell in which the UE was camped—or if the UE is leaving a cell then to identify the cell to which it is going to camp or to identify if the UE is being switched off, etc. With such additional information, the base station 5 that receives the message from the UE can share the information either with a core network node or directly with the relevant neighbouring base station 5 via the Xn interface (or another base station to base station interface as appropriate) that it has with that neighbouring base station. For example, if UEs are instructed only to send a message to the new base station 5A when they start camping on the new base station's cell, then the new base station 5A can use the information included in the message from the UE 3 to identify the previous cell on which the UE camped and can message, via the Xn interface, the old base station 5B that controls the previous cell to inform the old base station 5B that the UE 3 has stopped camping on the previous cell. In this way both the new base station 5A and the old base station 5B can update the estimated number of Idle mode UEs camping on their respective cells.

Furthermore, it will be appreciated that the system information which carries the trigger for the TA update procedure (or the new procedure mentioned above) may be tailored to specific types of UE. For example, a base station may be configured to broadcast such system information that is for all classes of UE, except low power/low complexity UEs such as Internet of Things (IoT) devices.

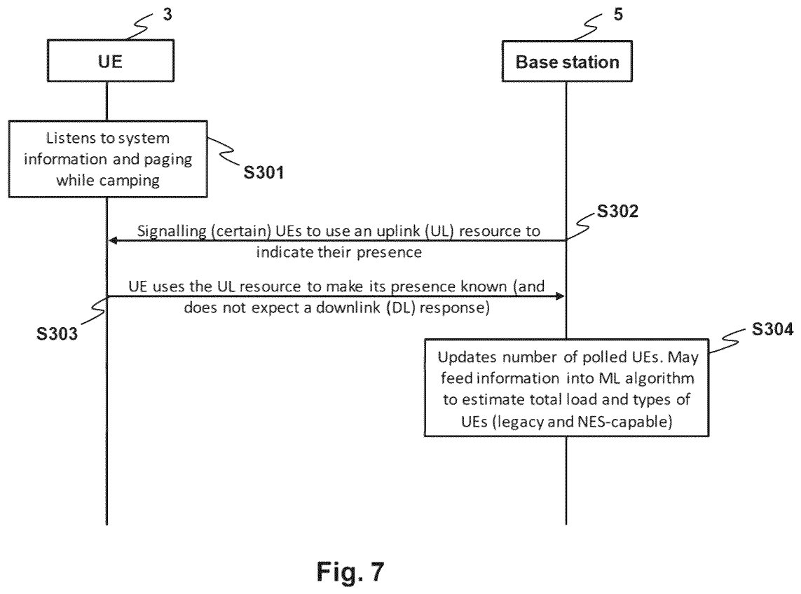

A further example embodiment of the present disclosure will now be described with reference to FIG. 7.

According to this example embodiment, the base station 5 polls UEs camping on its cell (i.e. using on-demand signalling, upon receipt of which UEs wake up and respond immediately). In this regard, the UE 3, operating in Idle mode, is configured to listen to system information or paging (S301) broadcast by the base station 5 in S302 (such as a wake up signal) which indicates to the UE 3 that the UE 3 is to make its presence known to the base station 5 via uplink resources which are reserved for this purpose (as discussed in more detail below).

Once the UE 3 has received the signalling sent in S302, the UE 3 wakes up and responds to the base station 5 in S303 using the reserved uplink resources to make its presence known to the base station 5, and indicating to the base station 5 that it does not expect a downlink (DL) response (as it will go back to sleep after it transmits its response to the base station 5). In S304, the base station 5 uses the responses received from the Idle mode UEs to update its estimate of the number of Idle mode UEs that are camped on its cell.

Beneficially, according to this example, UEs operating in Idle mode would only wake up to send a small uplink signal, using the reserved uplink resources, and then go back to sleep—using the reserved uplink resources in this way means the UE does not need to transition from Idle mode into Connected mode.

The reserved uplink resources may, according to one example, be a Msg1 preamble on a dedicated Physical Random Access Channel (PRACH) on a reserved preamble space. In this example, the reserved preamble space refers to a set of preambles (1 to 64 per PRACH resource) located in specified PRACH resource blocks that can be accessed by specific UEs (e.g. the uplink resource could be reserved for MTC devices if it is desired to poll to see how many Idle mode MTC devices are within a given tracking area at a specific point in time). If polled, a UE would randomly choose one of the set of 64 PRACH preambles typically available for Msg1 when signalling to the base station 5 (although it will be appreciated that in alternative telecommunications systems more than 64 or fewer than 64 preambles may be made available for a UE to select). As the UE is not expecting a response from the base station 5, the UE 3 can then go back to its sleep state.

Although UEs are not uniquely identified via PRACH preambles, via this process, the base station 5 has sufficient information to determine a reasonably accurate estimation of the number of Idle mode UEs (of the polled type of Idle mode UEs—which may be all Idle mode UEs). For instance, if 10 preambles are received from Idle mode UEs out of the 64 preambles available, this would indicate the presence of 10 Idle mode UEs in the cell with high probability, and would indicate with a lower probability the presence of 11, 12, or more Idle mode UEs. However, if fifty preambles are received, then there is a higher likelihood that multiple UEs have selected and transmitted the same preamble, and so the probability is higher that there will be more than fifty Idle mode UEs.

If the base station 5 operating the cell whose load is being calculated expects a high number of polled UEs (e.g. because the cell is located in a densely populated environment), a mechanism to reduce the number of polled UEs that will respond can be implemented. This can be achieved, for example, by selecting a probability p of accessing the reserved uplink resource, or by only allowing UEs that satisfy a condition (such as its Temporary Mobile Subscriber Identity (TMSI) mod N=0) to access the reserved uplink resource, and then estimating the actual load by multiplying the estimated number by 1/p or N. Calculating the load in a cell in this manner could prevent congestion, save reserved uplink resources and save UE energy consumption (on average, because in this example not all Idle mode UEs will have access to use the reserved uplink resource), albeit at the cost of a slightly less precise load estimation.

As with the example embodiments described above that used the existing TA update procedure, it is not necessary to use the existing PRACH polling procedure, other low power signalling procedures could be used instead, such as any low bandwidth low energy signalling (e.g. using a sounding reference signal, SRS).

An alternative to the polling procedure described above relates to the case where a cell can wake up a UE, via a paging request for polling purposes, and prompt the UE to access the PRACH to indicate its Idle mode status. Paging according to this example is performed on the PDSCH and is dedicated for a UE's ID with a dedicated PRACH occasion (time and frequency resource and a unique preamble signature—i.e. the RACH process in this example is “contention-free”), although all UEs in a given tracking area would need to be paged in this way. A paged UE responds to the base station's page, by transmitting Msg1 using the dedicated PRACH occasion. Since this paging procedure is for polling purposes, (and unlike normal paging that is typically used to connect a call through to a UE), the UE is configured to return to its sleep state after sending Msg1. That is the UE is not expecting Msg2 back from the base station 5. Similarly, after receiving the Msg1 from the paged UEs, the base station 5 is configured not to transmit Msg2 of the normal paging message sequence. The base station 5 can then count the responses received to determine the number of Idle mode UEs (or the number of the particular class of Idle mode UEs that were polled) that are camping in its cell, which information can then be used, for example, to make better decisions in relation to the NES configuration that the base station 5 should adopt. Of course, as this alternative uses a dedicated PRACH resource per UE, the energy costs of implementing such a paging procedure would need to be balanced against the prospective energy savings that could be attained by receiving information from UEs via this alternative, such that a NES configuration can be implemented that is beneficial to the network overall.

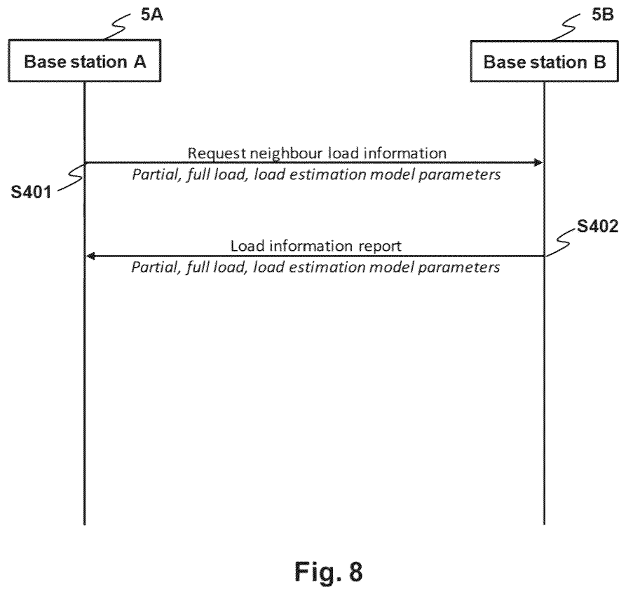

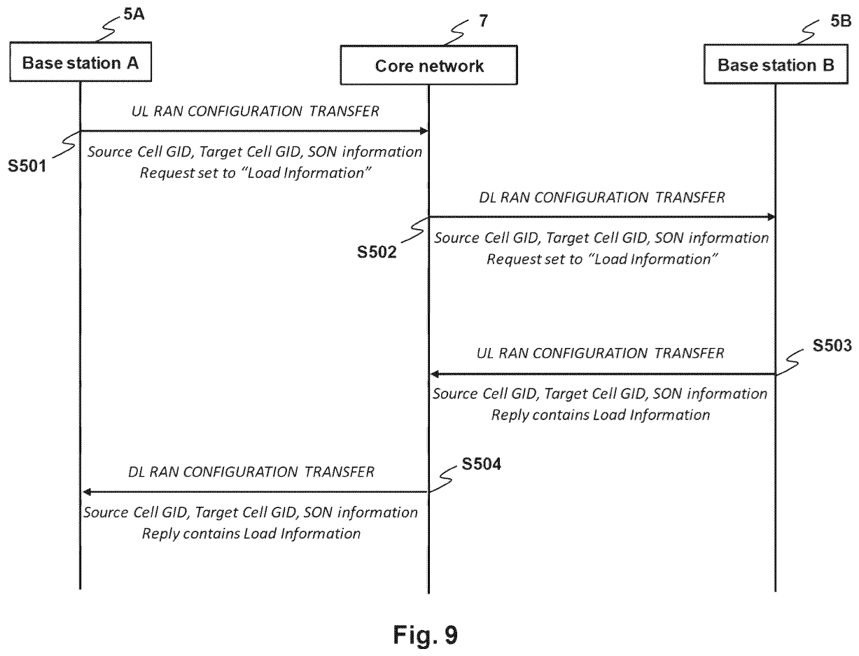

A further example embodiment of the present disclosure will now be described with reference to FIGS. 8 and 9. The core network 7 will have a record of the number of UEs that are camping in each tracking area, but at the base station level, however, only low/medium/high load of the cell formed by each respective base station 5 is currently reported to the core network 7.

A solution to determining more accurate load information of a neighbouring cell is shown in FIG. 8, which illustrates the use of an interface (such as an Xn interface) between the base stations 5A and 5B.

In S401, base station 5A commences its network energy saving evaluation by requesting load information of at least one its neighbouring base station, which in this example is base station 5B. The request identifies one or more parameters about which base station 5A wishes to receive a report from base station 5B to assist in its network energy saving decision. The request may indicate that it is acceptable to the base station 5A that it only receives partial information from the neighbour base station, e.g. if base station 5B does not know the precise number of legacy UEs in Idle mode, then the base station 5A can still obtain the other requested information (e.g. the type of cell operated by base station 5B) to assist in taking a network energy saving decision. Similarly, the request may also indicate that the base station 5A only wishes to receive full load information from the neighbouring base station 5B.

The load information request may comprise a request with respect to the capability of UEs in the neighbour cell, in addition load information parameters. Examples of these parameters include cell-specific information relating to UE traffic load in the cell, such as:
the number of UEs in Connected, Inactive and Idle mode (if available) in the neighbouring cell (beneficially, the neighbouring base station may determine the number of UE operating in Idle mode in the manner described in the previous example embodiments):
whether UEs operating in the neighbouring cell are network energy saving (NES)-capable or not: and
the typical QoS requirements for the traffic in the neighbouring cell.

Further parameters which base station 5A may request to be included in the load information report may relate to neighbour-cell specific information of base station 5B, such as:
the neighbouring cell's type (e.g. is the neighbouring cell a coverage cell or not);
details of handovers into/out of the neighbouring cell over a given time period;
the NES-pattern history of the neighbouring cell over a given time period; and
the typical traffic observed on the neighbouring cell over a given time period.

Base station 5B then replies to the request with a Load Information Report in S402, the report including the information requested by base station 5A. Once received, base station 5A may then proceed to evaluate and make its NES decision on which NES configuration to use depending on overall load on neighbouring cells as indicated in one or more received Load Information reports. For example, if the load information report requested by base station 5A indicates the number of UEs in the cell of base station 5B is low (say, 4 in Connected mode, 2 in Inactive mode and 1 in Idle mode), and hence that the load on that particular cell is also low, base station 5A may take a decision to activate NES by handing its UEs over to the cell of base station 5B and switching off power to its cell.

An alternative scenario to that of FIG. 8 is illustrated in FIG. 9, which sets out how base stations 5 may request and obtain the load information report as described above via the core network 7 (rather than via another base station directly over a base station to base station interface). In one example, the core network node that is involved in the process is the access management function (AMF) 8-1 of the 5G core network, and the base stations 5A and 5B are gNBs of the 5G access network.

In S501 of FIG. 9, base station 5A sends a message to the core network 7 which is destined for neighbouring base station 5B. This initial message may be a UL RAN CONFIGURATION TRANSFER message (having an interpretable request field set to “Load Information”, and hence this message can be considered as a load report request message). The message includes the source cell's global ID (GID) of the base station 5A, the target (neighbouring) cell's GID to which the request is addressed; and self-organising network (SON) information.

Once received, the core network 7 uses the target cell's GID to identify the target base station 5B and forwards base station 5A's request to base station 5B in S502. The core network node may forward the request via a DL RAN CONFIGURATION TRANSFER message having the same source cell GID, target Cell GID, SON information and Load Information request.

Base station 5B having received the request then replies to the DL RAN CONFIGURATION TRANSFER message with its own UL RAN CONFIGURATION TRANSFER message in S503, which contains the requested Load Information—which can include any or all of the parameters described above in the example embodiment of FIG. 8. This UL RAN CONFIGURATION TRANSFER message sets the Source Cell GID as the cell of the base station 5B, the target Cell GID as the source cell ID of the cell operated by the base station 5A so that the message will be routed back to the base station 5A by the core network 7. Again, beneficially, neighbouring base station 5B may determine the number of UEs operating in Idle mode in its cell using the techniques described above in the earlier example embodiments and include this information in its report response message.

The core network 7, having received the UL RAN CONFIGURATION TRANSFER message from base station 5B, then in S504 sends a DL RAN CONFIGURATION TRANSFER message (load report response message) to base station 5A containing the Load Information provided by the base station 5B. As set out above, base station 5A may then proceed to evaluate and make its NES decision on which NES configuration to use depending on overall load on neighbouring cells as indicated in one or more received DL RAN CONFIGURATION TRANSFER messages.

### Modifications and Alternatives

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

It will be appreciated that the above example embodiments may be applied to both 5G New Radio (5G NR) and LTE systems (E-UTRAN). The above example embodiments may also be applied to future systems (beyond 5G, 6G, etc.).

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency). It will be appreciated that the energy saving methods described in this document may be applicable to at least one of the above categories of UEs and/or at least one type of services. Different energy saving approaches (if any) may be applicable to different categories of UEs and/or different services.

In the above description, the UE, the access network node (base station), and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs) input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above exemplary example embodiments. It will be appreciated that pre-emption may be handled by the user-plane part of the base station without involving the control-plane part (or vice versa).

The above example embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; (motor) vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source; 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Caming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch eXchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the exemplary example embodiments disclosed above can be described as, but not limited to, the following supplementary notes.

### Supplementary Note 1

A method for an access network node for determining a network energy saving configuration, the method comprising:
transmitting a broadcast within a cell operated by the access network node to cause at least one User Equipment, UE, that is camping in the cell in an Idle mode to respond to the access network node;
receiving at least one response from at least one Idle mode UE among the at least one UE;
determining, using the at least one response, an estimate of the number of the at least one UE; and
determining the network energy saving configuration for the access network node using the number of the at least one UE.

### Supplementary Note 2

The method according to supplementary note 1, wherein the broadcast causes the at least one UE to transmit the at least one response in a case where at least one event occurs.

### Supplementary Note 3

The method according to supplementary note 2, wherein the at least one event is when the at least one UE starts to camp on the cell.

### Supplementary Note 4

The method according to supplementary note 3, further comprising: receiving, from a core network node or another access network node, first information for indicating when an Idle mode UE stops camping on the cell; and wherein
determining the network energy saving configuration is performed using the first information.

### Supplementary Note 5

The method according to supplementary note 2, wherein the at least one event is when the at least one UE is about to stop camping on the cell.

### Supplementary Note 6

The method according to supplementary note 5, further comprising:
receiving, from a core network node or another access network node, second information for indicating when an Idle mode UE starts camping on the cell; and wherein
determining the network energy saving configuration is performed using the second information.

### Supplementary Note 7

The method according to supplementary note 2, wherein the broadcast causes the at least one UE to transmit the at least one response when the UE starts to camp on the cell and when the UE is about to stop camping on the cell.

### Supplementary Note 8

The method according to any one of supplementary notes 1 to 7, wherein the broadcast causes the at least one UE to perform a Tracking Area Update.

### Supplementary Note 9

The method according to supplementary note 1, wherein the broadcast causes the at least one UE to transmit a message indicating presence of the at least one UE, to the access network node.

### Supplementary Note 10

The method according to supplementary note 9, wherein the broadcast causes the at least one UE to transmit the message to the access network node using an uplink resource that is dedicated for the at least one UE to transmit messages to the access network node.

### Supplementary Note 11

The method according to supplementary note 9 or 10, wherein the broadcast is a polling signal for the at least one UE to wake up, to transmit the message and to go back to sleep.

### Supplementary Note 12

The method according to any one of supplementary notes 9 to 11, wherein the broadcast causes the at least one UE to transmit the message without establishing a Radio Resource Control, RRC, connection with the access network node.

### Supplementary Note 13

The method according to any one of supplementary notes 9 to 12, wherein the receiving the at least one response is performed on a dedicated Physical Random Access Channel, PRACH.

### Supplementary Note 14

The method according to supplementary note 13, wherein the receiving the at least one response includes receiving randomly selected preambles from a set of available preambles.

### Supplementary Note 15

The method according to supplementary note 14, wherein the determining the estimate of the number of the at least one UE uses the number of the randomly selected preambles that are received.

### Supplementary Note 16

The method according to any one of supplementary notes 9 to 15, wherein the broadcast causes a subset of the at least one UE to transmit a message to the access network node, and wherein
the determining the estimate of the number of the at least one UE uses the at least one response received from the subset of the at least one UE.

### Supplementary Note 17

The method according to any one of supplementary notes 1 to 16, wherein the broadcast includes a Master Information Block, MIB, a System Information Block, SIB, or a paging message.

### Supplementary Note 18

The method according to any one of supplementary notes 1 to 17, further comprising:
receiving load information of another access network node or of the whole network, and wherein
the determining the network energy saving configuration for the access network node is performed by taking into account the load information.

### Supplementary Note 19

The method according to supplementary note 18, further comprising:
transmitting a request for the load information to a core network node or to another access network node; and wherein
the receiving the load information includes receiving from the core network node or the other access network node in response to the request.

### Supplementary Note 20

An access network node for determining a network energy saving configuration, the access network node comprising:
means for transmitting a broadcast within a cell operated by the access network node to cause at least one User Equipment, UE, that is camping in the cell in an Idle mode to respond to the access network node;
means for receiving at least one response from at least one Idle mode UE among the at least one UE;
means for determining, using the at least one response, an estimate of the number of the at least one UE; and
means for determining the network energy saving configuration for the access network node using the number of the at least one UE.

### Supplementary note 21

A method for a core network node of a telecommunications network, the method comprising:
maintaining a record of User Equipment, UE, that are operating in Idle mode within the telecommunications network, including, for each UE, an identifier of a cell on which they are camped;
receiving first information from a first access network node indicating that a first UE has started to camp on a cell of the first access network node; and
using the first information to update the record for the first UE to reflect the cell on which the UE has started to camp.

### Supplementary Note 22

The method of supplementary note 21, further comprising identifying a second access network node that controls a previous cell on which the first UE used to camp prior to the update and informing the second access network node that the UE is no longer camping on its cell.

### Supplementary Note 23

The method according to supplementary note 21 or 22, further comprising receiving, from an access network node, a load information request that requests load information of another access network node, and
sending load information for the other access network node that includes load information of any UEs that are camped on a cell of the other access network node.

### Supplementary Note 24

A core network node of a telecommunications network, the core network node comprising:
means for maintaining a record of User Equipment, UE, that are operating in Idle mode within the telecommunications network, including, for each UE, an identifier of a cell on which they are camped;
means for receiving first information from a first access network node indicating that a first UE has started to camp on a cell of the first access network node; and wherein the core network node is configured to use the first information to update the record for the first UE to reflect the cell on which the UE has started to camp.

### Supplementary Note 25

A method for a user equipment, UE, for assisting in determining a network energy saving configuration, the method comprising:
receiving a broadcast from an access network node within a cell operated by the access network node,
transmitting, to the access network node, a response in a case where the UE is operating in Idle mode,
wherein the response comprises:
a tracking area update in a case where the UE joins and/or leaves the cell operated by the access network node, or
a message indicating the presence of the UE in the cell operated by the access network node.

### Supplementary Note 26

A user equipment, UE, for assisting in determining a network energy saving configuration, the UE comprising:
means for receiving a broadcast from an access network node within a cell operated by the access network node,
means for transmitting, to the access network node, a response in a case where the
UE is operating in Idle mode,
wherein the response comprises:
a tracking area update in a case where the UE joins and/or leaves the cell operated by the access network node, or
a message indicating the presence of the UE in the cell operated by the access network node.

### Supplementary Note 27

A method for an access network node, the method comprising:
transmitting a broadcast in a cell operated by the access network node to cause at least one User Equipment, UE, that is camping in the cell in an Idle mode to transmit a preamble from a plurality of preambles on a random access channel;
receiving, from the random access channel, at least one preamble from at least one Idle mode UE among the at least one UE; and
determining, using the at least one preamble, an estimate of the number of the at least one UE.

### Supplementary Note 28

The method according to supplementary note 27, wherein the random access channel is a dedicated Physical Random Access Channel, PRACH.

### Supplementary Note 29

The method according to supplementary note 28, the method further comprising the step of:
reducing the at least one UE's access to the random access channel in a case where the broadcast indicates:
a probability p of accessing the dedicated PRACH, or
by only allowing UEs that meet a condition to access the dedicated PRACH.

### Supplementary Note 30

The method of supplementary note 29, wherein the condition is that its Temporary Mobile Subscriber Identity, TMSI, mod N=0.

### Supplementary Note 31

The method according to supplementary note 30, wherein the determining determines the estimated number of the at least one UE by multiplying the number preambles that the base station receives by 1/p or by N.

### Supplementary Note 32

The method according to any of supplementary notes 28 to 31, wherein the preamble is received in Msg1 of a random access procedure and the access network node does not transmit Msg2 of the random access procedure.

### Supplementary Note 33

A method for a User Equipment, UE, operating in Idle mode, the method comprising:
receiving a broadcast from an access network node within a cell operated by the access network node, the broadcast indicating that the UE should transmit a message on a random access channel indicating presence of the UE to the access network node;
selecting a preamble from a plurality of preambles;
transmitting a first message to the access network node on the random access channel, the first message including the selected preamble; and
returning to a sleep state after transmitting the first message.

### Supplementary Note 34

The method according to supplementary note 33, wherein the random access channel is a dedicated Physical Random Access Channel, PRACH.

### Supplementary Note 35

The method according to supplementary note 34, wherein the UEs' access to the random access channel is reduced in a case where the broadcast indicates a probability p of accessing the dedicated PRACH, or where the UE must satisfy a condition to access the dedicated PRACH.

### Supplementary Note 36

The method of supplementary note 35, wherein the condition is that its Temporary Mobile Subscriber Identity, TMSI, mod N=0.

### Supplementary Note 37

The method according to any one of supplementary notes 33 to 36, wherein the transmitting transmits Msg1 of a random access procedure.

### Supplementary Note 38

A User Equipment, UE, comprising:
means for receiving, when operating in Idle mode, a broadcast from an access network node within a cell operated by the access network node, the broadcast indicating that the UE should transmit a message on a random access channel indicating presence of the UE to the access network node;
means for selecting a preamble from a plurality of preambles;
means for transmitting a first message to the access network node on the random access channel, the first message including the selected preamble; and
means for returning to a sleep state after transmitting the first message.

### Supplementary Note 39

A method for an access network node for determining a network energy saving configuration, the method comprising:
transmitting a request for load information of another access network node or of a whole network;
receiving load information from a core network node or from the other access network node;
wherein the load information comprises one or more of the following information: the number of UEs in Connected, Inactive and/or Idle mode;
whether UEs operating in at least one cell neighbouring the access network node are network energy saving, NES, capable or not;
the typical quality of service, QoS, requirements for traffic in the at least one cell neighbouring the access network node;
the type of the at least one cell neighbouring the access network node;
details of handovers into/out of the at least one cell neighbouring the access network node over a given time period;
the NES-pattern history of the at least one cell neighbouring the access network node over a given time period; and
the typical traffic observed on the at least one cell neighbouring the access network node over a given time period; and
determining the network energy saving configuration for the access network node taking into account the load information.

### Supplementary Note 40

The method of supplementary note 39, wherein the request indicates that the access network node is to receive part of or all of the requested load information.

### Supplementary Note 41

An access network node comprising:
means for transmitting a request for load information of another access network node or of a whole network;
means for receiving load information from a core network node or from the other access network node;
wherein the load information comprises one or more of the following information: the number of UEs in Connected, Inactive and/or Idle mode;
whether UEs operating in at least one cell neighbouring the access network node are network energy saving, NES, capable or not;
the typical quality of service, QoS, requirements for traffic in the at least one cell neighbouring the access network node;
the type of the at least one cell neighbouring the access network node;
details of handovers into/out of the at least one cell neighbouring the access network node over a given time period;
the NES-pattern history of the at least one cell neighbouring the access network node over a given time period; and
the typical traffic observed on the at least one cell neighbouring the access network node over a given time period; and
means for determining the network energy saving configuration for the access network node taking into account the load information.

### Supplementary Note 42

A method for a network node, the method comprising:
receiving a request for load information; and
transmitting load information to a core network node or an access network node;
wherein the load information comprises one or more of the following information:
the number of UEs in Connected, Inactive and/or Idle mode;
whether UEs operating in at least one cell neighbouring an access network node are network energy saving, NES, capable or not;
the typical quality of service, QoS, requirements for traffic in at least one cell neighbouring the access network node;
the type of the at least one cell neighbouring the access network node;
details of handovers into/out of the at least one cell neighbouring the access network node over a given time period;
the NES-pattern history of the at least one cell neighbouring the access network node over a given time period; and
the typical traffic observed on the at least one cell neighbouring the access network node over a given time period.

### Supplementary Note 43

The method of supplementary note 42, wherein the request indicates that the network node is to receive part of or all of the requested load information.

### Supplementary Note 44

The method according to supplementary notes 42 or 43, wherein the request for load information is transmitted in a UL or DL RAN CONFIGURATION TRANSFER message having an indication set to Load Information, and wherein the load information is transmitted in a UL or DL RAN CONFIGURATION TRANSFER message to the core network node or the access network node.

### Supplementary Note 45

The method according to supplementary notes 43, wherein the UL and DL RAN CONFIGURATION TRANSFER messages comprise a Source Cell Global Identity, GID, and a Target Cell GID.

### Supplementary Note 46

A network node comprising:
means receiving a request for load information; and
means for transmitting load information to a core network node or an access network node;
wherein the load information comprises one or more of the following information:
the number of UEs in Connected, Inactive and/or Idle mode;
whether UEs operating in at least one cell neighbouring an access network node are network energy saving, NES, capable or not;
the typical quality of service, QoS, requirements for traffic in at least one cell neighbouring the access network node;
the type of the at least one cell neighbouring the access network node;
details of handovers into/out of the at least one cell neighbouring the access network node over a given time period;
the NES-pattern history of the at least one cell neighbouring the access network node over a given time period; and
the typical traffic observed on the at least one cell neighbouring the access network node over a given time period.

This application is based upon and claims the benefit of priority from Great Britain Patent Application No. 2209742.2, filed on Jul. 1, 2022, the disclosure of which is incorporated herein in its entirety by reference.

### Reference Signs List

1 TELECOMMUNICATION SYSTEM
3 MOBILE DEVICE
5 BASE STATION
6 CELLS
7 CORE NETWORK
8-1 AMF
8-2 CPF
8-3 UPF
8-4 SMF
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
45 ENERGY SAVING MODULE
51 TRANSCEIVER CIRCUIT
53 ANTENNA
55 NETWORK INTERFACE
57 CONTROLLER
59 MEMORY
61 OPERATING SYSTEM
63 COMMUNICATIONS CONTROL MODULE
65 ENERGY SAVING MODULE
71 TRANSCEIVER CIRCUIT
75 NETWORK INTERFACE
77 CONTROLLER
79 MEMORY
81 OPERATING SYSTEM
83 COMMUNICATIONS CONTROL MODULE
85 ENERGY SAVING MODULE

1. A method for an access network node, the method comprising:
transmitting broadcast information within a cell operated by the access network node to cause at least one User Equipment (UE) that is camping in the cell in an Idle mode to transmit a message to the access network node;
receiving the message from an Idle mode UE among the at least one UE, in a case where the Idle mode UE starts camping on the cell and/or stops camping on the cell, or the Idle mode UE wakes up from the Idle mode; and
determining, using the message, an estimate of the number of the at least one UE.

2. The method according to claim 1, further comprising:
determining a network energy saving configuration for the access network node using the number of the at least one UE.

3. The method according to claim 2, further comprising:
receiving, from a core network node or another access network node, first information for indicating when the Idle mode UE stops camping on the cell; and wherein
the determining the network energy saving configuration is performed using the first information.

4. The method according to claim 2, further comprising:
receiving, from a core network node or another access network node, second information for indicating when the Idle mode UE starts camping on the cell; and wherein
the determining the network energy saving configuration is performed using the second information.

5. (canceled)

6. The method according to claim 1, wherein the message indicates presence of the Idle mode UE.

7. The method according to claim 6, wherein the message is transmitted, by the Idle mode UE, using an uplink resource that is dedicated for the Idle mode UE to transmit the message to the access network node.

8. The method according to claim 6, wherein the broadcast information is a polling signal for the Idle mode UE to wake up, to transmit the message and to go back to sleep.

9. The method according to claim 6, wherein the message is transmitted, by the Idle mode UE, without establishing a Radio Resource Control (RRC) connection with the access network node.

10. The method according to claim 6, wherein the receiving the message is performed on a dedicated Physical Random Access Channel (PRACH).

11. The method according to claim 10, wherein the message includes a preamble, randomly selected by the Idle mode UE from a set of available preambles.

12. The method according to claim 11, wherein the determining the estimate of the number of the Idle mode UE is performed by using the number of type of the randomly selected preambles that are received.

13. (canceled)

14. The method according to claim 11, further comprising:
reducing the Idle mode UE's access to the dedicated PRACH in a case where the broadcast information indicates:
a probability p of accessing the dedicated PRACH, or
by only allowing UEs that meet a condition to access the dedicated PRACH.

15-17. (canceled)

18. The method according to claim 2, further comprising:
receiving load information of another access network node or of a whole network, and wherein
the determining the network energy saving configuration for the access network node is performed by taking into account the load information.

19. The method according to claim 18, further comprising:
transmitting a request for the load information to a core network node or to the other access network node; and wherein
the receiving the load information includes receiving from the core network node or the other access network node in response to the request.

20. (canceled)

21. The method of claim 1920, wherein the request indicates that the access network node is to receive part of or all of the load information.

22-23. (canceled)

24. A method for a core network node, the method comprising:
maintaining a record of at least one User Equipment (UE) in an Idle mode, including, for each of the at least one UE in the Idle mode, an identifier of a cell on which the each of the at least one UE in the Idle mode is camped;
receiving first information from a first access network node indicating that a first UE has started to camp on a cell of the first access network node; and
using the first information to update the record for the first UE to reflect the cell on which the first UE has started to camp.

25-26. (canceled)

27. A method for a user equipment (UE) in an Idle mode, the method comprising:
receiving broadcast information within a cell operated by an access network node,
transmitting, to the access network node, a message in a case where the UE starts camping on the cell and/or stops camping on the cell, or the UE wakes up from the Idle mode, and wherein
the message is used, by the access network node, to determine an estimate of the number of at least one UE that is camping in the cell in the Idle mode.

28. An access network node comprising:
at least one memory; and
at least one hardware processor coupled to the at least one memory,
wherein the at least one hardware processor is configured to:
transmit broadcast information within a cell operated by the access network node to cause at least one User Equipment (UE) that is camping in the cell in an Idle mode to transmit a message to the access network node;
receive the message from an Idle mode UE among the at least one UE, in a case where the Idle mode UE starts camping on the cell and/or stops camping on the cell, or the Idle mode UE wakes up from the Idle mode; and
determine, using the message, an estimate of the number of the at least one UE.

29. A core network node comprising:
at least one memory; and
at least one hardware processor coupled to the at least one memory,
wherein the at least one hardware processor is configured to:
maintain a record of at least one User Equipment (UE) in an Idle mode, including, for each of the at least one UE in the Idle mode, an identifier of a cell on which the each of the at least one UE in the Idle mode is camped;
receive first information from a first access network node indicating that a first UE has started to camp on a cell of the first access network node; and
use the first information to update the record for the first UE to reflect the cell on which the first UE has started to camp.

30. A user equipment (UE) in an Idle mode, the UE comprising:
at least one memory; and
at least one hardware processor coupled to the at least one memory,
wherein the at least one hardware processor is configured to:
receive broadcast information within a cell operated by an access network node,
transmit, to the access network node, a message in a case where the UE starts camping on the cell and/or stops camping on the cell, or the UE wakes up from the Idle mode, and wherein
the message is used, by the access network node, to determine an estimate of the number of at least one UE that is camping in the cell in the Idle mode.
